(19) United States
(12) Patent Application Publication
(10) Pub. No.: US 2013/0112896 A1
(43) Pub. Date: May 9, 2013

(54) PLATINUM-BASED INFRARED LIGHT SOURCE FOR GAS DETECTION

(71) Applicant: Axetris AG, Kagiswil (CH)

(72) Inventors: Olivier DUBOCHET, Kagiswil (CH); Stefan KREBS, Alpnach (CH)

(73) Assignee: AXETRIS AG, Kagiswil (CH)

(21) Appl. No.: 13/670,652

(22) Filed: Nov. 7, 2012

(30) Foreign Application Priority Data
Nov. 9, 2011 (EP) 11 401 626.4

(51) Int. Cl. H05B 33/04

(52) U.S. Cl. 250/504 R

(57) ABSTRACT

An infrared radiation source for gas detection, with a thin layer infrared radiator that is arranged in the interior chamber of a protective housing that includes a support surface for the thin layer infrared radiator and an exit window for the infrared radiation arranged at a distance opposite the support surface. The thin layer infrared radiator includes a platinum layer and at least one structurally defined de-gassing canal with an entry opening and an exit opening that leads from the interior chamber of the protective housing to the outside. For non-critical applications, the de-gassing canal is not sealed. For critical applications, it may be sealed by a sealing membrane that is water impermeable, water vapor permeable and open for gas diffusion, with the sealing membrane preferably being semi-permeable.

### CROSS-REFERENCE TO RELATED APPLICATION

The present application claims priority under 35 USC§119 to European Patent Application No. 11 401 626.4 filed Nov. 9, 2011, the entire disclosure of which is incorporated herein by reference.

### TECHNICAL FIELD OF THE INVENTION

The invention relates to an infrared light source for gas detection with a thin layer infrared radiator that is arranged in the interior chamber of a protective housing that comprises a support surface for the infrared radiator and, arranged at a distance opposite the support surface, an exit window for the infrared radiation.

### DESCRIPTION OF THE RELATED ART

The use of infrared spectroscopy for the detection or analysis of gases is a well-known method. Essentially, it comprises the emission of infrared radiation ahead of an optical transmission path and the optical detection of this radiation after the transmission path. The optical detection of the infrared absorption analysis makes use of the fact that in the presence of the target gas to be detected in the transmission path a certain spectral range of the infrared light that is specific for the target gas is distinctly attenuated. Commonly, a gas sensor for the optical detection of target gases that is suitable for infrared spectroscopy consists of an infrared radiation source and an infrared radiation detector that are arranged on both sides of the optical transmission path. Within the transmission path, also called absorption path, certain wavelengths of the infrared radiation are absorbed in dependence on the gas or gas mixture in the area of the absorption path, with the degree of the absorption depending on the concentration of the target gas. The gas selectivity for a target gas of such an optical gas sensor is achieved by selecting either an infrared radiation source that emits within a narrow band and that emits only within the special wavelength band of the target gas, or by using an infrared radiation source emitting within a wide band, in which case a transmission filter for the specific wavelength is present in the absorption path.

As high-power infrared radiation sources with wide-band emission, platinum-based infrared radiators are known in prior art. Such infrared radiators usually have a monolithic structure and comprise a partial piece of a silicon wafer with a membrane that is formed with a silicon nitride layer and carries a thin heatable platinum layer that is connected adhesively to the silicon nitride layer via a thin layer of tantalum, titanium, chromium and/or one of these. In order to protect the infrared radiator from environmental influences, such thin layer infrared radiators are usually used in encapsulated configuration, i.e. they are arranged in a hermetically sealed protective housing. As protective housing, TO housings are known, for example, that comprise a bottom surface as the support surface for the thin layer infrared radiator and, facing the bottom surface, a hermetically sealed exit window for the infrared radiation emitted by the infrared radiator.

It was found that hermetically sealed infrared radiation sources, when operated in the vicinity of the intended nominal power, are destroyed after a relatively short period of operation as a consequence of the platinum layer delaminating from the thin layer membrane of silicon nitride. The destruction process is a function of temperature, i.e. it is enhanced by higher operating temperatures. Infrared radiation sources that are not hermetically sealed are not affected by this problem.

It could be shown that an increased hydrogen concentration inside the hermetically sealed housing is responsible for the delamination and subsequent destruction of the platinum layer. The harmful hydrogen is contained in the silicon chip of the infrared radiation source and in the metal components of the protective housing. After the hermetical sealing of the infrared radiation source, this hydrogen is released continuously by outgassing and may reach concentrations of up to 0.5% in gas-tight housings. Especially when the infrared radiation source is being operated, the free hydrogen is split catalytically into atomic hydrogen on the platinum layer which then diffuses through the platinum layer, reducing the tantalum pentoxide layer or other layers arranged beneath it, and forming water as the reaction product. Due to the high operating temperature of the infrared radiation source, the resulting water is enclosed in gaseous form and with high gas pressure between the membrane and the platinum layer, and this leads to a detachment of the platinum layer from the membrane and thereby to a destruction of the infrared radiation source.

Hermetic sealing of the infrared radiation source in protective gas does not solve this problem because the outgassing of the hydrogen proceeds independently of the other gases within the hermetically sealed housing. Also, the introduction of a getter material for hydrogen into the protective housing, as known from the disclosure of US 2004/238 763 A1, solves the problem only within limits because the dimensioning of the getter for the required life of the infrared radiation source is problematic and the installation of such a getter involves high space requirements. A getter of this type represents an additional high cost factor for the production of the infrared radiation source.

Hermetic sealing of the infrared radiation source with air as the filler gas for the protective housing also does not prevent the destruction of the platinum layer. This only slows down the delamination of the platinum layer since the atomic hydrogen is able to react directly with the molecular oxygen of the filler gas to produce water that is not enclosed between the platinum layer and the membrane. However, due to the high operating temperatures of the infrared radiation source, the organic adhesives that are used for gluing the infrared radiation source to the support surface, for example, will oxidize to form carbon dioxide whose concentration may reach up to 9%. The rising carbon dioxide and water vapor concentrations inside the protective housing make the infrared radiation source unsuitable for their use as drift-free moisture or CO₂ sensors. In addition, after the maximum CO₂ concentration is reached, the destruction already described above takes place because the gaseous oxygen has been consumed and the reduction of the tantalum oxide layer will therefore begin.

Starting with the prior art referred to above, the invention addresses the problem of proposing a solution that specifically and reliably prevents the destruction of the infrared radiation source during operation with nominal power while avoiding an increased hydrogen concentration in the protective housing of the infrared radiation source without making use of getter material.

### SUMMARY OF THE INVENTION

The infrared radiation source according to the invention comprises a thin layer infrared radiator with a thin platinum layer, a de-gassing canal with an entry opening and an exit opening is provided that leads from the interior chamber of the otherwise hermetically sealed protective housing to the outside. The de-gassing canal is structurally defined, i.e. its geometry is of special design and it is to be provided at specially selected places of the protective housing. The entry opening is arranged at one inner surface of the protective housing, and the exit opening is arranged on the outer surface of the protective housing, with the de-gassing canal extending at any suitable place of the protective housing. This makes it possible for de-gassed hydrogen, carbon dioxide, or water vapor that may form to diffuse continually to the outside so that no significant increases in concentration of these gaseous substances will occur inside the protective housing. This reliably avoids not only the destruction of the infrared radiation source by hydrogen but also a falsification of the gas measurement due to changing water vapor or carbon dioxide concentrations.

The cross-sectional area of the de-gassing canal is selected specifically to prevent larger-size particles from entering the protective housing from the environment that might spread in the interior chamber between the platinum layer and the exit window or might form deposits on the platinum layer or the exit window.

In one embodiment of the invention, the de-gassing canal that has a typical cross-sectional diameter of 1 mm-2 mm is not closed. Such an infrared radiation source for gas detection according to the invention can be used, for example, for non-critical applications and/or in an environment with little pollution of the surrounding atmosphere.

Preferably, the exit opening and/or the entry opening of the de-gassing canal are arranged on a surface and/or an edge of the protective housing. The de-gassing canal may be formed by a bore or by a milled-out feature. It may also be formed by a defined interruption of a welded, fritted, glued, or sealed section of the protective housing.

In principle, the de-gassing canal provided in the infrared radiation source according to the invention may extend between the entry opening and the exit opening in a straight line or with a single or multiple bends or angles. According to the invention, a combination of such extension sections may also be provided. The extension direction of the de-gassing canal may change once or multiple times in any direction.

Preference is given to an embodiment of the infrared radiation source according to the invention where the de-gassing canal extends between the entry opening and the exit opening in the form of a labyrinth. While this has only an insignificant influence on the exit of hydrogen, water vapor and/or carbon dioxide from the interior chamber of the protective housing, it will significantly impede the intrusion of gases from the outside that usually also carry along polluting particles. Possibly entering polluting particles will advantageously collect on the walls of the de-gassing canal and will therefore not enter the interior chamber and will not come in contact with the infrared radiation source.

For more critical applications, for example in an environment heavily polluted with dust and/or moisture, the de-gassing canal is preferably sealed by means of a sealing membrane that is impermeable to water, permeable for water vapor, and open for gas diffusion. As sealing membrane, a membrane known under the trade name “Gore Tex” may be used in this context, for example. “Gore Tex” is a membrane consisting of polytetrafluor ethylene that is water impermeable and open for vapor diffusion, and therefore also open for gas diffusion. It is used mainly in the clothing industry for the manufacture of functional textile materials and has an air-permeable, grid-like structure.

For special critical applications where the intrusion of the target gas or other aggressive gases from the environment into the protective housing of the infrared radiation source according to the invention must be reliably prevented, the sealing membrane is preferably implemented as a semi-permeable membrane made of Kapton, Teflon, or Silcion [sic], for example. Semi-permeability describes the characteristic of substantial or physical boundary surfaces, often of membranes, of being semi-permeable or partially permeable. Such membranes permit only molecules below a certain size and therefore below a certain mass to pass.

Also, the sealing membrane may consist of a thin metal foil. Hydrogen in particular is known for being able to diffuse through such metal foils while larger molecules are unable to do so. For this purpose, the metal foil may be glued on or soldered on.

Here, the sealing membranes may be implemented as a flat disk or as spatial structures that preferably extend uniformly in all spatial directions. In a preferred embodiment of the invention, the sealing membrane is implemented as a flat disk and is arranged and fixed in place outside at the exit opening of the de-gassing canal. In another embodiment, the sealing membrane is implemented identically as a flat structure but is arranged and fixed in place in the de-gassing canal. The fixing is achieved at the edge of the disk-shaped sealing membrane, by glueing or clamping, for example. For clamping, a counter support is necessary that may be formed by an annular step in the de-gassing canal. Preferably, the sealing membrane is pressed against the annular step by means of a tube-shaped pressed-in part, and is thereby clamped.

In another advantageous embodiment of the infrared radiation source according to the invention, the sealing membrane is cartridge-shaped and inserted partially or completely in the de-gassing canal and fixed there. Regardless of the specific design as either a flat disk or as a three-dimensional cartridge, the sealing membrane is connected to the de-gassing canal in each case in such a way that a seal relative to the outside is formed.

For connecting to a circuit board, as regards the mechanical attachment and electrical contact, two principally different embodiments of the protective housing of the infrared radiation source according to the invention may be chosen. It can either be designed with electrical connecting wires for assembly by insertion on the circuit board, or with electrical contact strips for surface mounting on the circuit board. If the exit opening of the de-gassing canal is located on a surface facing the circuit board or on a correspondingly associated edge, and if there is only a small or no gap between the circuit board and the protective housing when mounted on the circuit board, it is an advantage if the circuit board has a hole facing the exit opening of the de-gassing canal through which the de-gassing canal can communicate with the environment without impedance. For conventional mounting, the protective housing may be designed as transistor-outline housing and for surface mounting as a dual-inline housing, for example. In both cases, the protective housing may comprise beam-shaping elements for the infrared radiation that are integrated into the protective housing on the inside or adapted on the outside.

Below, the invention is explained in detail with reference to several embodiments shown in the drawing. Additional characteristics of the invention are given in the following description of the embodiment of the invention in conjunction with the claims and the attached drawing. The individual characteristics of the invention may be realized either individually by themselves or in combinations of several in different embodiments of the invention.

### BRIEF DESCRIPTION OF THE DRAWINGS

FIG. 1 shows a first embodiment of an infrared radiation source according to the invention with a protective housing for mounting by insertion on circuit boards, with the de-gassing canal arranged on a bottom surface of a TO housing far from the edge;

FIG. 2 shows a second embodiment of an infrared radiation source according to the invention with a protective housing for mounting by insertion on circuit boards, with the de-gassing canal arranged on a bottom surface of a TO housing close to the edge;

FIG. 3 shows the embodiment from FIG. 1 with a flat sealing membrane for sealing the de-gassing canal that is arranged on the outside at the exit opening of the de-gassing canal and is attached there all around;

FIG. 4 shows the embodiment from FIG. 1 with a flat sealing membrane for sealing the de-gassing canal that is arranged inside the de-gassing canal and is fixed there on an annular step by means of all-around clamping; and

FIG. 5 shows the embodiment from FIG. 1 with a sealing membrane implemented as a cartridge that is held in the de-gassing canal and is fixed there at the outer circumference by means of pressing.

### DETAILED DESCRIPTION OF THE INVENTION

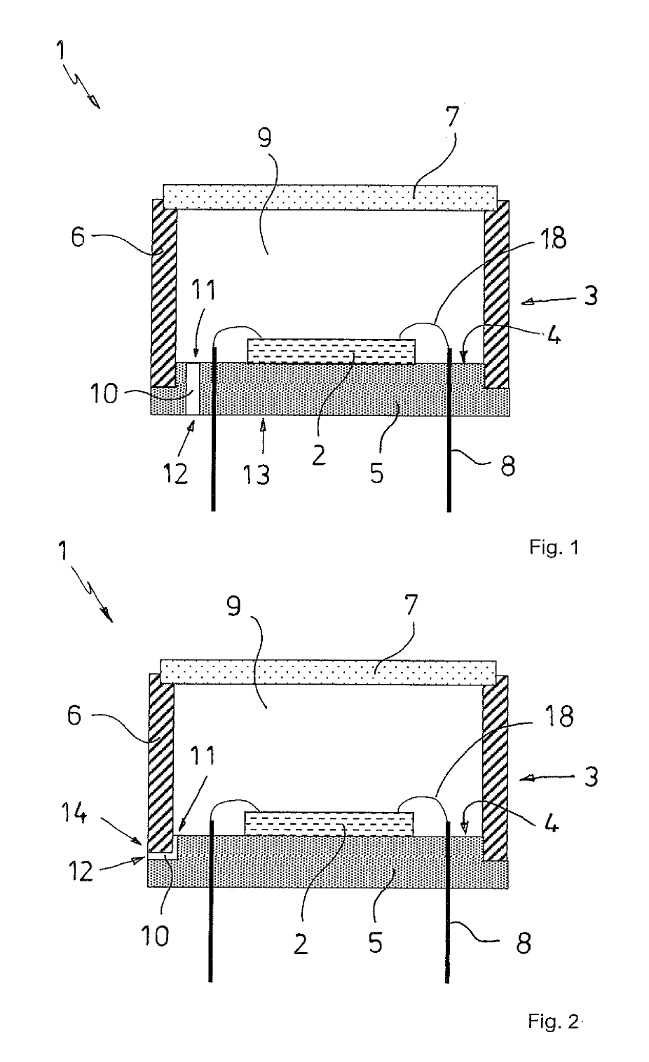

FIGS. 1 to 5 show the above-listed embodiments of the infrared radiation source 1 for gas detection according to the invention, each in a schematic longitudinal section view. Here, a thin layer infrared radiator 2 is arranged in a largely hermetically sealed protective housing 3 on a support surface 4 and fixed in place by means of gluing. The protective housing 3 is designed as a transistor-outline housing and comprises a bottom 5, a sidewall 6, and an exit window 7 permeable for infrared light opposite the bottom 5, all of these being connected to each other so that a gas-tight seal is created. Electrical connecting wires 8 pass through the bottom 5 into the interior chamber 9 of the protective housing 3 and are connected by means of the electrical connecting lines 18 to the thin layer infrared radiator 2 arranged on the support surface 4. Next to the infrared radiator 2, a de-gassing canal 10 is arranged, with an entry opening 11 associated with the interior chamber 9 at one end and with an exit opening 12 at the other end.

The de-gassing canal 10 leads from the interior chamber 9 of the protective housing 3 to the outside. In FIGS. 1 and 2 it is open. FIG. 1 shows a de-gassing canal 10 of this type that is implemented as a bore and therefore extends in a straight line between the entry opening 11 and the exit opening 12 far from the edge through the bottom 5 of the protective housing 3, and therefore at a lateral distance from the sidewall 6 of the protective housing 3. The bottom 5 forms a surface 13 of the protective housing 3. FIG. 2 shows a variant of such a de-gassing canal 10 that is formed by milled-out edge portions of the bottom 5 and the sidewall 6 that are associated with each other. The milled-out portions form a defined interruption at a lateral edge 14 of the protective housing 3 where the sidewall 6 and the bottom 5 are otherwise connected to each other, forming a seal. In this case, the de-gassing canal 10 is designed with a single angle.

Through the open de-gassing canal 10 with a typical diameter of approximately 1-2 mm, hydrogen, water vapor, or carbon dioxide, that are generated during the operation of the platinum-based infrared radiation source and would accumulate in the interior chamber 9 at high concentrations and high pressure in the absence of the de-gassing canal 10, are passed to the outside without any problems. The length and the form of the de-gassing canal 10 between the entry opening 11 and the exit opening 12 are not significant.

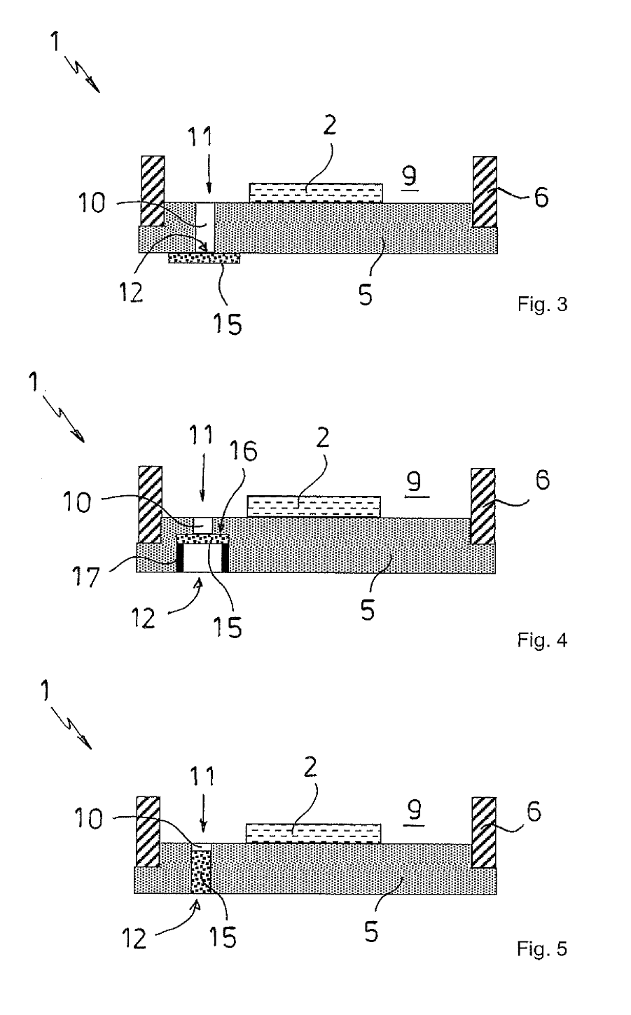

FIGS. 3 to 5 show the embodiment from FIG. 1 in a modified version where the de-gassing canal 10 is sealed by means of a sealing membrane 15 that is water-impermeable and open to moisture and gas diffusion, and that is preferably semi-permeable. In the embodiments shown in FIGS. 3, 4, the sealing membrane 16 is implemented as a flat disk, while the sealing membrane 15 shown in the embodiment in FIG. 5 has the shape of a three-dimensional cartridge. The sealing membrane 15 seals the de-gassing canal 10 especially in the direction from the exit opening 12 to the entry opening 11 so that, depending on the material chosen for the sealing membrane 15, the intrusion of water, water vapor, and gases in clean and contaminated condition into the interior chamber 9 of the protective housing 3 is prevented. In the opposite direction, i.e. from the entry opening 11 to the exit opening 12, gases or water vapor are able to diffuse unimpeded from the interior chamber 9 to the outside.

In the embodiment according to FIG. 3, the sealing membrane is arranged outside on the bottom 5, overlapping the exit opening 12. It is glued with its edge to the bottom 5. In the embodiment according to FIG. 4, the sealing membrane 15 is arranged in the de-gassing canal 10 and fixed there by clamps. For this purpose, the de-gassing canal 10 is formed with an annular step 16 which the sealing membrane 15 contacts with its edge. By means of a press-in part 17, it is pressed against the annular step 16. In the embodiment according to FIG. 5, the cartridge-shaped sealing membrane 15 is held by means of a press fit in the de-gassing canal 10.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An infrared radiation source for gas detection, with a thin layer infrared radiator that is arranged in the interior chamber of a protective housing that comprises a support surface for the thin layer infrared radiator and an exit window for the infrared radiation arranged at a distance opposite the support surface, wherein that the thin layer infrared radiator comprises a platinum layer, and that at least one structurally defined de-gassing canal with an entry opening and an exit opening leads from the interior chamber of the protective housing to the outside.

2. The infrared radiation source according to claim 1, wherein in that the entry opening and/or the exit opening of the de-gassing canal are arranged on a surface and/or an edge of the protective housing.

3. The infrared radiation source according to claim 1, wherein in that the de-gassing canal is formed by a bore or a milled-out feature.

4. The infrared radiation source according to claim 1, wherein in that the de-gassing canal is formed by a defined interruption of a welded, fritted, glued, or sealed section of the protective housing.

5. The infrared radiation source according to claim 1, wherein in that the de-gassing canal extends in the form of a labyrinth between the entry opening and the exit opening.

6. The infrared radiation source according to claim 1, wherein in that the de-gassing canal is sealed by means of a sealing membrane that is water-impermeable, water vapor permeable and open for gas diffusion.

7. The infrared radiation source according to claim 1, wherein, characterized in that the sealing membrane is semi-permeable.

8. The infrared radiation source according to claim 6, wherein in that the sealing membrane is implemented as a flat disk and is arranged and fixed outside on the exit opening.

9. The infrared radiation source according to claim 6, wherein in that the sealing membrane is implemented as a flat disk and is arranged and fixed in the de-gassing canal.

10. The infrared radiation source according to claim 6, wherein in that the sealing membrane is implemented in the form of a cartridge and is arranged and fixed inside the de-gassing canal.

11. The infrared radiation source according to claim 1, wherein in that the sealing membrane is implemented as a thin metal foil.

12. The infrared radiation source according to claim 11, wherein in that the sealing membrane is soldered on at the exit opening.

13. The infrared radiation source according to claim 1, wherein in that the protective housing is implemented with electrical connecting wires for insertion mounting on a circuit board.

14. The infrared radiation source according to claim 1, wherein in that the protective housing is implemented with electrical connecting strips for surface mounting on a circuit board.
